(19) United States
(12) Patent Application Publication
(10) Pub. No.: US 2003/0053758 A1
(43) Pub. Date: Mar. 20, 2003

(54) Optical fiber for precision mounting in substrate V-grooves

(76) Inventor: Thomas D. Monte, Lockport, IL (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 09/957,574

(22) Filed: Sep. 20, 2001

(51) Int. Cl. G02B 6/16; G02B 6/26

(52) U.S. Cl. 385/52; 385/123; 385/137

(57) ABSTRACT

An optical fiber for controlling and maintaining an orientation of the core of the fiber within a V-groove has one or more surfaces formed on the fiber whose shapes conform to the shape of the groove. The fiber can be fabricated with two surfaces shaped to match those of the V-groove, or can have one surface shaped to align with one side of the V-groove. The orientation of the core in the V-groove is determined by the orientation of the shaped surface(s) relative to the core. Additionally, the two surfaces can be shaped to allow alternative core orientations dependent on which surface is aligned with the V-groove.

### FIELD

The invention is directed to optical fibers, and more particularly to optical fibers to be mounted on substrates.

### BACKGOUND

Silicon is a standard substrate material for integrated optic components. Semiconductor, silica, polymer and hybrid design, active and passive devices may be routinely built on silicon wafers.

With the silicon substrate, wet etched V-grooves may offer precise alignment of optical fibers to couple light into and out of the integrated optic circuits. Polarization control and maintenance may be paramount since many of these devices exhibit polarization dependent properties.

In order to control and maintain polarization, optical fibers may be fabricated with elliptical cores. Elliptical core polarization maintaining fibers and other polarization maintaining fibers are well-known in the art. A circular-clad, elliptical core, polarization maintaining fiber may be mounted in the V-groove of a substrate using a fixant material, such as epoxy, to fix the fiber in the groove.

Typical fabrication techniques for V-grooves in silicon substrates may yield an included groove angle of 70.52°. Unless the fiber is precisely aligned, the elliptical core of the fiber may be oriented at an angle with respect to the substrate surface. The polarization coupling due to this angular offset is given in terms of an extinction ratio. The extinction ratio is the ratio of the optical powers polarized in two orthogonal defined transverse directions. The extinction ratio in decibels is related to the angular offset θ by: ER_{dB}(θ)=10 Log₁₀((tan²(θ)). For example, the extinction ratios for 0.5°, 1°, 2° and 5° misalignments are −41.18 dB, −35.16 dB, −29.14 dB and −21.16 dB, respectively. In order to align the transverse angular orientation of a circular clad fiber, an active measurement technique must be used. This active alignment adds to the expense of the photonic package. Also, active alignment is an inconvenience, since some devices may require power prior to the final assembly of the device at a stage in the manufacturing process before the appropriate interconnects are added. Furthermore, depending on the mating photonic device, it may be very difficult or impossible to measure the throughput polarization signals, which are required for the active alignment process as the extinction ratio of the optical fiber to photonic device interface may be masked by other components further down the optical signal path.

### SUMMARY

According to the methods and devices disclosed herein, an orientation of an optical fiber within a substrate groove may be controlled by forming at least one surface on the fiber conforming in shape to at least one corresponding surface of the groove. A known distance between the at least one surface on the fiber and a core of the fiber may determine a location of the core in relation to the groove when the chosen surface on the fiber is in contact with the corresponding surface of the groove.

In one embodiment, an orientation of an optical fiber within a groove may be controlled by forming a flat first surface on the fiber to conform with a flat shape of at least one chosen surface of the groove. The flat first surface of the fiber may form a predetermined angle with a major axis of an elliptical core of the fiber so as to determine the orientation of the fiber within the groove when the flat first surface on the fiber is in contact with the chosen surface of the groove.

In yet another embodiment, an orientation of an optical fiber within a groove may be controlled by forming two flat surfaces on the fiber to conform with a flat shape of two surfaces of the groove, wherein an included angle, β, between the surfaces on the fiber is related to an included angle, α, between the surfaces of the groove, by a geometric relationship where β≅α.

A further embodiment may control an orientation of an optical fiber within a groove by forming two flat surfaces on the fiber, each flat surface conforming with a shape of a surface of the groove, wherein an included angle, β, between the surfaces on the fiber is related to an included angle, α, between the surfaces of the groove, by a geometric relationship where β≅90°−α.

Thus, the embodiments as described may be directed to optical fibers having geometric features, which facilitate fiber core orientation alignment when inserted in substrate V-grooves. In these embodiments, the orientation of the core of the fiber when placed in the V-groove is determined by the orientation of the surfaces formed on the fiber relative to the core of the fiber. With the alignment control provided by shaping the fibers, polarization control and maintenance may be enhanced in connections between polarization sensitive components.

### BRIEF DESCRIPTION OF THE DRAWINGS

The following figures depict certain illustrative embodiments in which like reference numerals refer to like elements. These depicted embodiments are to be understood as illustrative and not as limiting in any way.

FIGS. 1a and 1b show cross-sectional representations of an embodiment of the present optical fiber mounted in a substrate V-groove with surfaces shaped to match the V-groove;

FIGS. 2a and 2b show cross-sectional representations of another embodiment of the present optical fiber mounted in a substrate V-groove with a surface shaped to match the V-groove; and

FIGS. 3a and 3b show alternative mounting orientations for a cross-sectional representation of a further embodiment of the present optical fiber mounted in a substrate V-groove with surfaces shaped to match the V-groove.

### DETAILED DESCRIPTION OF CERTAIN ILLUSTRATED EMBODIMENTS

As is well-known in the art, the manufacturing process for polarization preserving fiber can include grinding a circular fiber preform to produce one or more flat surfaces (flats), which can be carefully orientated with respect to the birefringence axes, i.e., with respect to the axes of the elliptical core of the fiber. After the drawing process, the geometric features of the preform are preserved in the surface of the optical fiber.

It is understood that other manufacturing or fabrication techniques as are known in the art also may be used for obtaining flats on optical fiber surfaces. These techniques optionally may be used for preparing the fibers described herein. As used herein, flat surfaces or flats denote the generally flat surfaces that can be obtained through the use of the techniques noted above.

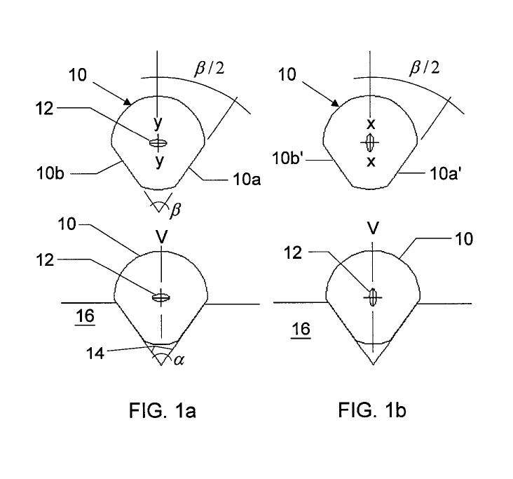

Referring to FIG. 1a, there is shown circular-clad polarization preserving optical fiber 10. Fiber 10 may include flat inclined surfaces 10a and 10b, forming an angle β there between and an angle β/2 with an axis of elliptical core 12 of fiber 10. The angle β may be chosen to conform with the included angle α of V-groove 14 of substrate 16, which as described for silicon substrates may be 70.52°. For clarity and ease of designation, fiber 10 of FIG. 1a is shown both above and within V-groove 14. (The fibers in FIGS. 1b, 2a, 2b, 3a and 3b are similarly depicted.) Preferably, the spacing of surfaces 10a and 10b from core 12 may be such as to maintain the fiber strength and facilitate splicing to other fibers (not shown). It is also noted that the spacing of surfaces 10a and 10b from core 12 will also determine a depth at which fiber 10 seats within V-groove 14.

In the embodiment of FIG. 1a, flat surfaces 10a and 10b may form angle β/2 with minor axis y-y of core 12. Thus, when fiber 10 is positioned in V-groove 14, core 12 may have its major axis x-x oriented horizontally. For the embodiment of FIG. 1b, flat surfaces 10a′ and 10b′ may form angle β/2 with major axis x-x of core 12, thus core 12 may have its major axis x-x oriented vertically. It is noted that major axis x-x or minor axis y-y need not be aligned with the vertical axis V of V-groove 14, as shown in FIGS. 1b and 1a, respectively, and other alignments of major axis x-x or minor axis y-y with vertical axis V may be chosen.

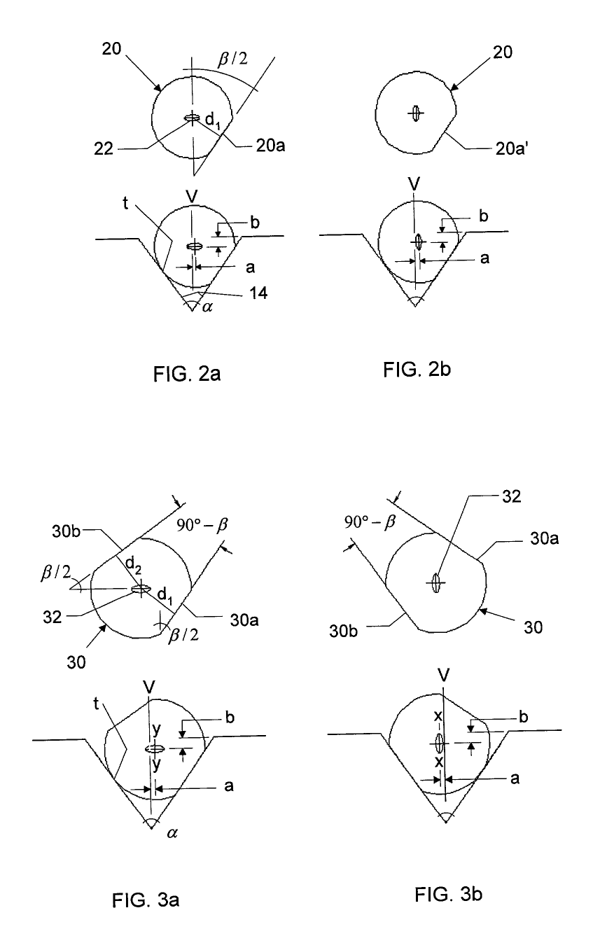

Referring now to FIG. 2a, fiber 20 may have one inclined flat surface 20a. Surface 20a may be oriented with respect to core 22 of fiber 20 and V-groove 14 as surface 10a is to core 12 of fiber 10 and V-groove 14. When placed in V-groove 14, flat surface 20a may align with V-groove 14 and fiber 20 may also contact V-groove 14 at tangent point t. The embodiment of FIG. 2a may result in core 22 being offset a horizontal distance a within V-groove 14, as well as a vertical distance b, depending on a distance d, between surface 20a and core 22. Thus, connections with other fibers or components (not shown) utilizing the V-groove 14 for alignment may require adjustment for offsets a and b. FIG. 2b shows fiber 20, which may have a surface 20a′ with an orientation rotated 90° from that of surface 20a of FIG. 2a. As was noted for FIGS. 1a and 1b, alignments other than those shown for surfaces 20a and 20a′ may be chosen so as to vary the orientation of axes x-x and y-y with vertical axis V.

Referring now to FIG. 3a, flat inclined surface 30a of fiber 30 may have the same orientation with minor axis y-y of core 32, i.e., angle β/2, as do surfaces 10a and 20a of FIGS. 1a and 2a, respectively. Thus when placed in V-groove 14, flat surface 30a may align with and contact one flat surface of V-groove 14, and fiber 30 also may contact V-groove 14 at tangent point t. Minor axis y-y of core 32 may then be aligned with vertical axis V and core 32 may be offset within V-groove 14.

Additionally, flat inclined surface 30b of fiber 30 may form angle β/2 with major axis x-x, thus forming an angle (90°−β) between surface 30a and surface 30b. When placed in V-groove 14 such that surface 30b may align with and contact one flat surface of V-groove 14, as shown in FIG. 3b, the orientation of core 32 may be rotated 90° from that of FIG. 3a.

Fiber 30, with surfaces 30a and 30b, can have application when it may be desired to rotate the polarization between a first V-groove and a second V-groove. Fiber 30 may be looped, twisted, or otherwise configured such that surface 30a may align with one of the V-grooves and surface 30b may align with the other V-groove. The V-grooves may be on the same substrate or on separate substrates as the application may dictate.

As was noted for FIGS. 1a and 1b, alignments other than those shown for surfaces 30a and 30b with respect to the core 32 may be chosen so as to vary the orientation of axes x-x and y-y with vertical axis V. For FIGS. 3a and 3b, the radial distances d₁ and d₂, from a center of fiber 30 to surfaces 30a and 30b, respectively, may also be varied.

The fibers 10, 20 and 30, as described, may have significant advantages when used in applications where controlling or maintaining core orientation may be desired. Angular alignment accuracies below 1° may be achievable with the V-flat optical fiber passive alignment scheme disclosed, providing extinction ratios below −35 dB. As optical data rates increase to 40 Gbits per second and further, the polarization properties of integrated optic and bulk optical fiber components can no longer be ignored and maintaining and controlling the optical polarization at these accuracies may be required. Additionally, the fibers as described may be advantageous in maintaining the fiber within the V-groove such that twists in the fiber may be eliminated. Further, the fibers as described may be advantageous in maintaining the core at a certain location within the V-groove, such as shown by offset a. Thus the fibers, as described, and as in other embodiments as will be readily evident to those skilled in the art, may find applicability to fibers having cores with shapes other than the elliptical shapes of cores 12, 22 and 32 and in varying positions within the fibers.

While the invention has been disclosed in connection with the preferred embodiments shown and described in detail, various modifications and improvements thereon will become readily apparent to those skilled in the art.

Though shown with a generally circular fiber, other fiber shapes may also be adapted to incorporate the inclined surfaces shown in the figures. As an example, D-shaped fibers, or D-fibers, have a flat face surface formed such that the core may be accessible for interactions with other optical fibers or devices. By forming one or more additional flat surfaces as described herein, the D-fiber can be aligned in a V-groove such that the flat face surface is oriented parallel with the substrate surface (perpendicular with vertical axis V). For example, a D-fiber having a flat face perpendicular to the minor axis y-y of its elliptical core may be provided with two flat surfaces according to FIG. 1a at an angle β/2 with core minor axis y-y, or with one flat surface according to FIG. 2a, while a D-fiber having a flat face perpendicular to the major axis x-x of its elliptical core may be provided with two flat surfaces according to FIG. 1b at an angle β/2 with core major axis x-x, or with one flat surface according to FIG. 2b. Optionally, the radial distances d of the flat surfaces provided from the core may be adjusted in order to adjust the vertical location of the flat face of the D-fiber with respect to the substrate surface. Such D-fibers may find application in interconnecting silicon mounted modules with metal clad polarizers or other devices, such as polarization controllers, phase or amplitude modulators, gratings, etc., which can be built on the flat face surface of the D-fiber.

In another example, an aluminized optical fiber can be permanently bonded to silicon surfaces by fusion without any adhesive, as described in U.S. Pat. No. 5,389,193 to Coucoulas et al. Thus, in combination with the methods described herein, precise angular alignment can be achieved without the use of adhesives. Such adhesives can contaminate other components of a photonics package, and if their use can be avoided, the design of the photonics package can be significantly simplified.

In a further example, integrated optic waveguides built on silicon substrates may have large index contrast and corresponding tighter elliptical shaped mode fields. Mode matching tapers can be incorporated into the interface waveguides to minimize loss when butt coupled to the standard low index contrast (and corresponding larger mode field) circular core fibers. If two silicon substrate based modules, with mode matching tapers, are to be connected via the standard fiber, then a polarization preserving fiber with a tighter mode field may simplify the scheme by eliminating the mode matching tapers. Therefore, a higher index contrast polarization fiber combined with the methods described herein, provides a solution to angular orientation and mode field matching of integrated optic circuits mounted on silicon substrates.

In yet another example, the methods described may find particular advantage in aligned arrays of polarization maintaining fibers, which may find use in pigtailing to polarization sensitive devices or in coupling multiple fibers simultaneously.

As was noted, standard etching processes in silicon may produce V-grooves with an angle α of 70.52 degrees. However, the V-groove angle α and the composition of the substrate material may not form a part of this application except as the angle β may relate to V-groove angle a. Thus, the fibers as described may be used with other configurations of grooves, with the flat surfaces modified to conform with the groove configuration. It will be understood that fabrication tolerances for both the substrate and the surfaces formed on the fiber may result in angles differing slightly from those stated herein. Angular differences (B−α) in a range of +/−5° may still provide reasonable axis alignment. The acceptable angular differences will depend on the desired extinction ratio for the contemplated application, as previously described. Thus, references to specific angles are understood to include such angular differences.

Accordingly, the spirit and scope of the present invention is to be limited only by the following claims.

What is claimed is:

1. A method for controlling an orientation of an optical fiber within a groove, comprising:
(a) forming at least one surface on the fiber to conform in shape to at least one surface of the groove, and
(b) placing the at least one surface on the fiber in contact with the at least one surface of the groove;
such that a known distance between the at least one surface on the fiber and a core of the fiber determines a location of the core in relation to the groove.

2. The method of claim 1, wherein the core of the fiber is elliptical in shape, having a major axis and a minor axis, and a known angle formed between the at least one surface of the fiber and one of the axes of the core determines the orientation of the fiber within the groove.

3. The method of claim 2, wherein the groove comprises two flat surfaces disposed with a known groove angle between them.

4. The method of claim 3, wherein:
(a) the step of forming the at least one surface on the fiber to conform in shape to the at least one surface of the groove comprises forming two flat surfaces on the fiber, disposed such that the angle between the two surfaces equals the known groove angle; and
(b) the step of placing the at least one surface on the fiber in contact with the at least one surface of the groove comprises placing the two surfaces on the fiber in contact with the two surfaces of the groove.

5. The method of claim 4, wherein the bisector of the angle between the two flat surfaces is parallel to the major axis of the core.

6. The method of claim 4, wherein the bisector of the angle between the two flat surfaces is parallel to the minor axis of the core.

7. The method of claim 4, wherein the bisector of the angle between the two flat surfaces bears a predetermined angular relationship to one of the axes of the core.

8. The method of claim 3, wherein:
(a) the step of forming the at least one surface on the fiber to conform in shape to the at least one surface of the groove comprises forming one flat surface on the fiber: and
(b) the step of placing the at least one surface on the fiber in contact with the at least one surface of the groove comprises placing the surface on the fiber in contact with one of the faces of the groove.

9. The method of claim 8, wherein the flat surface is at an angle to the major axis of the core which equals one half of the known groove angle.

10. The method of claim 8, wherein the flat surface is at an angle to the minor axis of the core which equals one half of the known groove angle.

11. The method of claim 8, wherein the flat surface is at a predetermined angle to one of the axes of the core.

12. The method of claim 3, wherein:
(a) the step of forming the at least one surface on the fiber to conform in shape to the at least one surface of the groove comprises forming a first flat surface and a second flat surface on the fiber, disposed such that the angle between the two surfaces equals 90° minus the known groove angle; and
(b) the step of placing the at least one surface on the fiber in contact with the at least one surface of the groove comprises placing one surface on the fiber in contact with one surface of the groove.

13. The method of claim 12, wherein the first flat surface is at an angle to the major axis of the core which equals one half of the known groove angle.

14. The method of claim 3, wherein the fiber has a flat face.

15. The method of claim 14, wherein:
(a) the step of forming the at least one surface on the fiber to conform in shape to the at least one surface of the groove comprises forming two flat surfaces on the fiber, disposed such that the angle between the two surfaces equals the known groove angle, and the bisector of the angle between the two surfaces is perpendicular to the flat face; and
(b) the step of placing the at least one surface on the fiber in contact with the at least one surface of the groove comprises placing the two surfaces on the fiber in contact with the two surfaces of the groove.

16. The method of claim 14, wherein:
(a) the step of forming the at least one surface on the fiber to conform in shape to the at least one surface of the groove comprises forming one flat surface on the fiber, disposed such that the flat surface is at an angle to the flat face which equals 90° minus one half of the known groove angle; and
(b) the step of placing the at least one surface on the fiber in contact with the at least one surface of the groove comprises placing the surface on the fiber in contact with one of the faces of the groove.

17. An optical fiber, comprising:
(a) a first flat surface on the fiber; and
(b) a second flat surface on the fiber,
wherein an included angle between the first and second flat surfaces on the fiber is substantially equal to 70.52°.

18. The fiber of claim 17, wherein the bisector of the angle between the two flat surfaces is parallel to a major axis of an elliptical core of the fiber.

19. The fiber of claim 17, wherein the bisector of the angle between the two flat surfaces is parallel to a minor axis of an elliptical core of the fiber.

20 An optical fiber, comprising:
(a) a first flat surface on the fiber; and
(b) a second flat surface on the fiber,
wherein an included angle between the first and second flat surfaces on the fiber is equal to 19.480.

21. The fiber of claim 20, wherein the first flat surface is at an angle of substantially 35.26° with respect to a major axis of an elliptical core of the fiber.

22. An optical fiber, comprising:
(a) a flat face on the fiber;
(b) a first flat surface on the fiber; and
(c) a second flat surface on the fiber,
wherein an included angle between the first and second flat surfaces on the fiber is substantially equal to 70.52°.

23. The fiber of claim 22, wherein the bisector of the angle between the two flat surfaces is perpendicular to the flat face.

24. An optical fiber, comprising:
(a) a flat face; and
(b) a first flat surface on the fiber.

25. The fiber of claim 24, wherein the flat surface is at an angle of substantially 54.74° with respect to the flat face.
